(19) United States
(12) Patent Application Publication
(10) Pub. No.: US 2026/0222783 A1
(43) Pub. Date: Jul. 30, 2026

(54) SMART STRUCTURE FOR ELECTRONIC DEVICE STORAGE, IDENTIFICATION, AND CONFIGURATION

(71) Applicant: SIGNIFY HOLDING B.V., EINDHOVEN (NL)

(72) Inventors: VOYA VIDAKOVIC, MARIETTA, GA (US); NAM CHIN CHO, PEACHTREE CITY, GA (US)

(21) Appl. No.: 19/146,571

(22) PCT Filed: Jan. 9, 2024
(86) PCT No.: PCT/EP2024/050334

§ 371 Date: Jul. 9, 2025

Related U.S. Application Data
(60) Provisional application No. 63/438,080, filed on Jan. 10, 2023.

(30) Foreign Application Priority Data
Feb. 13, 2023 (EP) 23156215.8

(51) Int. Cl. H04W 4/80

(52) U.S. Cl. CPC H04W 4/80

(57) ABSTRACT

A system for identifying and configuring one or more electronic devices arranged on a support structure is provided. The support structure may be a pallet, a point-of-sale display stand, or a storage module. The system includes a support structure controller and one or more support structure transceivers associated with the support structure. The support structure controller includes a memory storing device identification data and device configuration data. The support structure transceivers are communicatively coupled to the support structure controller. The one or more support structure transceivers are each configured to (1) transmit an RFID activation signal to the one or more electronic devices, (2) receive the device identification data transmitted by the one or more electronic devices in response to receiving the RFID activation signal, and (3) transmit the device configuration data to the one or more electronic devices.

### FIELD OF THE DISCLOSURE

The present disclosure is directed generally to storing, identifying, and configuring electronic devices on a support structure.

### BACKGROUND

Configurable electronic devices (such as luminaires and light sources) are typically programmed with default settings during manufacturing. These default settings are used to streamline the variations of the electronic devices being produced. However, these electronic devices often require specific programming in a retail environment prior to reaching the end customer. Further, these electronic devices should be monitored for inventory control purposes, whether they are stored in a warehouse or displayed in the retail environment. Accordingly, there is a need in the art for improved systems for storing, configuring, and monitoring electronic devices prior to reaching the end customer.

### SUMMARY OF THE DISCLOSURE

The present disclosure is directed generally to storing, configuring, and monitoring electronic devices on a support structure. In particular, the present disclosure focuses on a support structure, such as a pallet, container, or point-of-sale display associated with a support structure controller and one or more support structure transceivers. The support structure may be plastic, metal, or any other appropriate material or combination of materials and is shaped and dimensioned to receive, support, and display electronic devices thereon. The support structure transceivers communicate with a radio frequency identification (RFID) tag on the electronic devices to retrieve device identification data for storage in a memory of the support structure controller. The support structure controller then provides the support structure transceivers with device configuration data to be transmitted to the electronic devices. In this way, the electronic devices may be monitored and configured during storage or in-store display.

The support structure controller may be integrated into the support structure. For example, the support structure controller may be built into a pallet, container, or a point-of-sale display shelf. The integrated support structure controller may be powered by a battery built into the support structure. In other examples, the support structure is retrofit with the support structure controller which is arranged on or within the support structure.

The system may utilize a single support structure transceiver coupled to a loop antenna. The loop antenna is arranged around the perimeter of the support structure, enabling the support structure transceiver to communicate with any electronic device placed within the perimeter. In other configurations, the system may utilize several support structure transceivers, each with their own discrete antenna configured to communicate with the electronic devices positioned within a portion of the support structure. By using several support structure transceivers to cover different portions of the support structure, coverage of the entire support structure may be achieved.

The support structure controller may be in communication with a central controller, such as via Wi-Fi or Bluetooth connection. For example, if the support structure is arranged in a warehouse, the central controller may be positioned within an office, equipment room, or server room of the warehouse. A user can use the central controller (via an interface of the central controller or a connected computing device) to provide device configuration data to the support structure controller for programming the electronic devices. For example, if the electronic device is a luminaire, the user can provide the central controller settings regarding correlated color temperature (CCT) or lumen output. Further, the central controller can be used to collect device identification data retrieved from the electronic devices. The device identification data may include device type, device weight, manufacturing location, date code, batch number, and/or lot number. Based on the collected device identification data, the central controller can provide the support structure controller with device configuration data corresponding to the device type or other device identification data. Further, the central controller could use the device identification data to identify pallets or containers to be picked to fill an order. In this example, the central controller may provide the support structure controller with inventory control data to trigger activation of audio and/or visual notification devices associated with the support structure. These audio/or visual notification devices may also be actuated for theft prevention purposes. The central controller could also use the device identification data to generate inventory reports or other types of data required by the user.

The support structure may also include one or more sensors. The sensors may be configured to capture a wide array of data, such as temperature data, humidity data, weight data, or any other data relevant to the storage, retrieval, monitoring, and configuration of the electrical devices on the support structure.

Generally, in one aspect, a system for identifying and configuring one or more electronic devices arranged on a support structure is provided. The system includes a support structure controller. The support structure controller is associated with the support structure. The support structure controller includes a memory and a processor. The memory stores device identification data and device configuration data. According to an example, the one or more electronic devices are luminaires, and the device configuration data includes a CCT and/or a lumen output. The support structure may be a pallet, a point-of-sale display stand, or a storage module. The device identification data may include device type, device weight, manufacturing location, date code, batch number, and/or lot number.

The system further includes one or more support structure transceivers. The one or more support structure transceivers are associated with the support structure. The one or more support structure transceivers are communicatively coupled to the support structure controller. The one or more support structure transceivers are each configured to transmit an RFID activation signal to the one or more electronic devices. The one or more support structure transceivers are each further configured to receive the device identification data transmitted by the one or more electronic devices. The device identification data is transmitted by the one or more electronic devices in response to receiving the RFID activation signal. The one or more support structure transceivers are each further configured to transmit the device configuration data to the one or more electronic devices.

According to an example, a support structure transceiver of the one or more support structure transceivers may be electrically coupled to a loop antenna. The loop antenna is arranged around a perimeter of the support structure. The one or more electronic devices are arranged within the perimeter.

According to an example, the one or more support structure transceivers are arranged at one or more locations on or within the support structure. Each of the one or more support structure transceivers is electrically coupled to an antenna.

According to an example, the support structure controller is communicatively coupled to a central controller. Further to this example, the support structure controller is configured to (1) transmit the device identification data to the central controller and (2) receive the device configuration data from the central controller. The device configuration data corresponds to the device identification data. In a further example, the support structure controller may be configured to actuate one or more audio notification devices and/or visual notification devices associated with the support structure. The actuation may be based on inventory control data received from the central controller. In an even further example, the support structure controller is further configured to receive sensor data from one or more sensors associated with the support structure. The support structure controller is configured to transmit the sensor data to the central controller. The sensor data may include temperature data, humidity data, and/or weight data.

According to an example, the support structure controller and/or the one or more support structure transceivers are arranged on or within the support structure. Alternatively, the support structure controller and/or the one or more support structure transceivers may be integrated within the support structure.

Generally, in another aspect, a method for identifying and configuring one or more electronic devices arranged on a support structure is disclosed. The method includes associating a support structure controller with the support structure. The support structure controller includes a memory and a processor. The memory stores device identification data and device configuration data.

The method further includes associating one or more support structure transceivers with the support structure. The one or more support structure transceivers are communicatively coupled to the support structure controller.

The method further includes transmitting, via the one or more support structure transceivers, an RFID activation signal to the one or more electronic devices.

The method further includes receiving, via the support structure controller, the device identification data. The device identification data was transmitted by the one or more electronic devices in response to receiving the RFID activation signal.

The method further includes transmitting, via the one or more support structure transceivers, the device configuration data to the one or more electronic devices.

According to an example, the method further includes transmitting, via the support structure controller, the device identification data to a central controller. The method may further include receiving, via the support structure controller, the device configuration data from the central controller. The device configuration data corresponds to the device identification data.

According to an example, the method further includes receiving, via the support structure controller, sensor data from one or more sensors associated with the support structure. The sensor data may include temperature data, humidity data, and/or weight data. The method may further include transmitting, via the support structure controller, the sensor data to a central controller. The method may further include receiving, via the support structure controller, inventory control data transmitted from a central controller. The method may further include actuating, based on the inventory control data, one or more audio notification devices and/or visual notification devices associated with the support structure.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software, firmware, or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a top view of a support structure controller, according to aspects of the present disclosure.

FIG. 2 is a schematic drawing of components of the support structure controller, according to aspects of the present disclosure.

FIG. 3 is a block diagram of a system for identifying and configuring an electronic device, according to aspects of the present disclosure.

FIG. 4 is an illustration of a top view of a support structure having a support structure controller communicatively coupled to a loop antenna, according to aspects of the present disclosure.

FIG. 5 is an illustrations of a top view of a support structure having a support structure controller communicatively coupled to four discrete antennas, according to aspects of the present disclosure.

FIG. 6 is an isometric view of a system for identifying and configuring an electronic device integrated into a support structure, according to aspects of the present disclosure.

FIG. 7 is an isometric view of a system for identifying and configuring an electronic device retrofit onto a support structure, according to aspects of the present disclosure.

FIG. 8 is an exploded view of a loop antenna retrofit onto a support structure, according to aspects of the present disclosure.

FIG. 9 is a flowchart of a method for identifying and configuring one or more electronic devices, according to aspects of the present disclosure.

FIG. 10 is a further flowchart of the method for identifying and configuring one or more electronic devices, according to aspects of the present disclosure.

### DETAILED DESCRIPTION OF EMBODIMENTS

The present disclosure is directed generally to storing, configuring, and monitoring electronic devices on a support structure. In particular, the present disclosure focuses on a support structure, such as a pallet, container, or point-of-sale display associated with a support structure controller and one or more support structure transceivers. The support structure may be plastic, metal, or any other appropriate material or combination of materials. The support structure transceivers communicate with a radio frequency identification (RFID) tag on the electronic devices to retrieve device identification data to be stored in a memory of the support structure controller. The support structure controller then provides the support structure transceivers device configuration data to be transmitted to the electronic devices. In this way, the electronic devices may be monitored and configured during storage or in-store display.

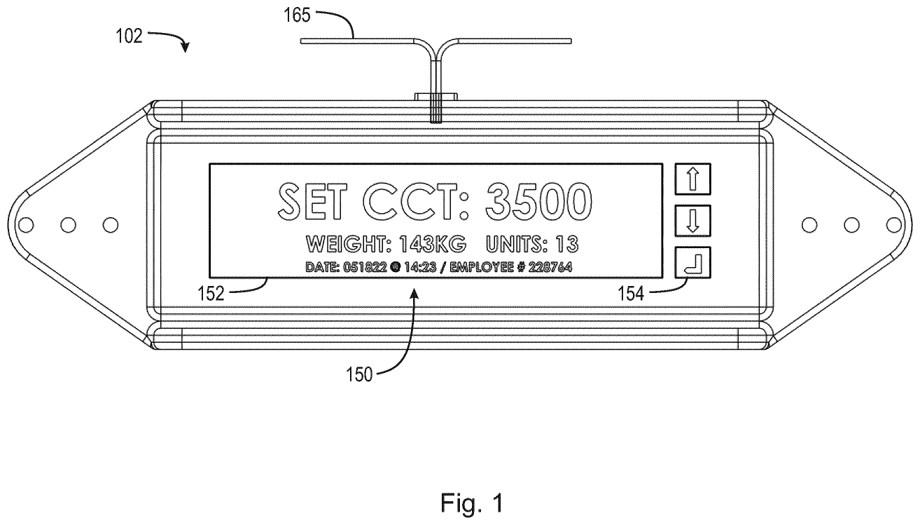

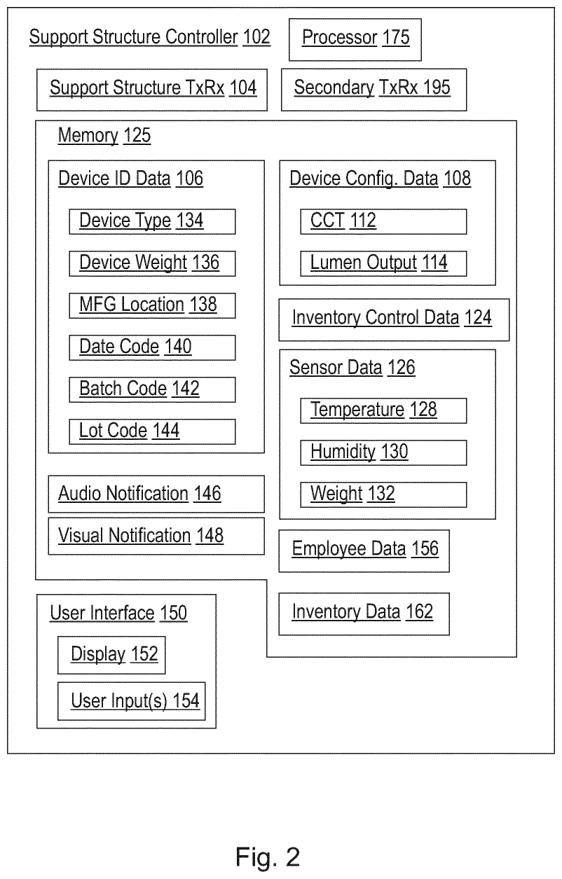

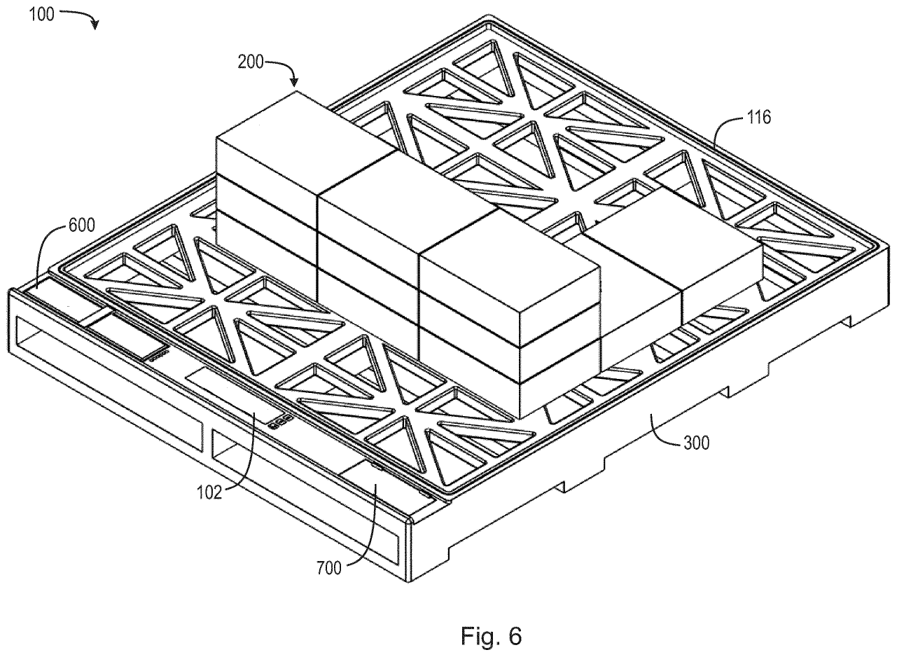

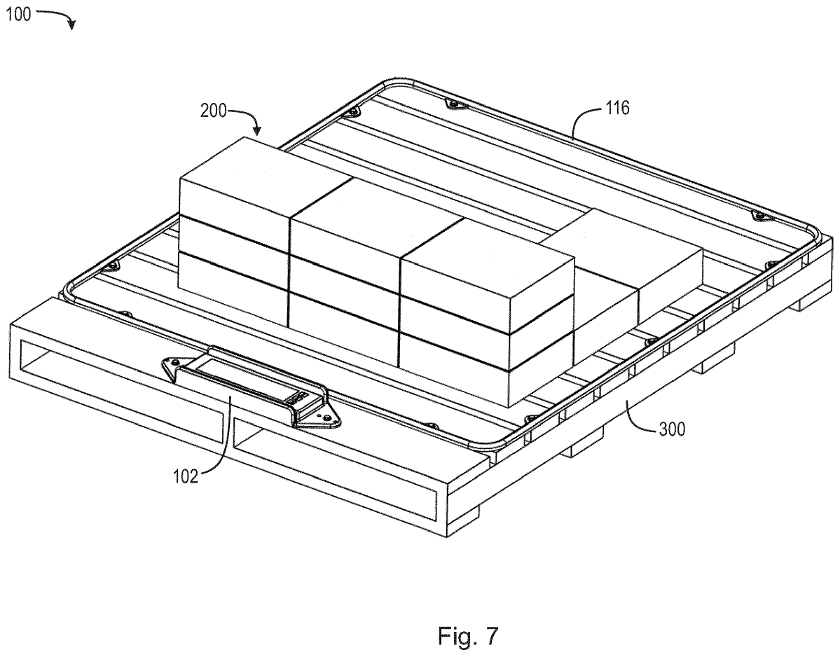

FIG. 1 illustrates a top view of a support structure controller 102 of a system 100 for identifying and configuring electronic devices 200 according to various embodiments and implementations of the present disclosure. Further, FIG. 2 schematically illustrates the internal components of the support structure controller 102. As will be shown, the support structure controller 102 is associated with a support structure 300 (see FIGS. 6 and 7), such as a pallet, container, point-of-sale display, or any other structure capable of storing and physically supporting one or more electronic devices 200 (see FIGS. 6 and 7). In a preferred example, the electronic devices 200 are configurable light sources and light fixtures, such as light modules and luminaires configured to provide illumination via a plurality of light emitting diodes (LEDs). In these examples, the support structure controller 102 may capture information regarding the luminaires via RFID communication in the form of device identification data 106 (see FIG. 2). Further, the support structure controller 102 may configure various settings of the luminaires through the transmission of device configuration data 108 (see FIG. 2).

As will be described with reference to subsequent figures, the support structure controller 102 may be coupled to (e.g., mechanically, wired, communicatively, wirelessly), connected to, disposed on, integrated into (e.g., built as a component of), arranged on or within a support structure 300. For example, an existing wooden or plastic pallet may be retrofit with the system 100 for identifying and configuring electronic devices 200 by arranging, affixing, or attaching a support structure controller 102 to an interior or exterior of the pallet via screws, bolts, fasteners, and/or any other means of attachment.

In the non-limiting example of FIG. 1, the support structure controller 102 includes a user interface 150, including a display 152 and three user inputs 154 (in this example, buttons). The display 152 may be used to show aspects of inventory data 162 (see FIG. 2) related to the electronic devices 200 stored on or in the support structure 300. In the example of FIG. 1, the display 152 indicates that the corresponding support structure 300 currently holds thirteen electronic devices 200 weighing 143 kilograms total. The display 152 further indicates the current date and time (14:23 on May 18, 2022) and the employee number (228764) of the user currently operating the support structure controller. The employee number may be an aspect of employee data 156 (see FIG. 2) wirelessly captured by the support structure controller 102 via, for example, RFID communication. Further, the user may use the display 152 and the user inputs 154 to manually command the support structure controller 102 to configure the electronic devices 200. In the example of FIG. 1, the user has manually commanded the support structure controller 102 to configure the electronic devices 200 to a correlated color temperature (CCT) of 3500 K.

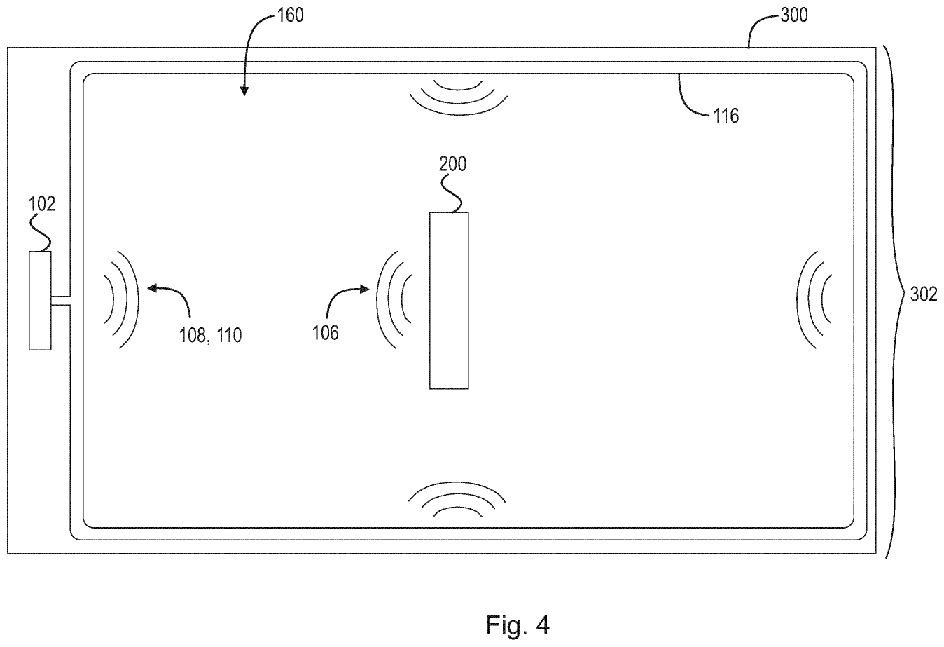

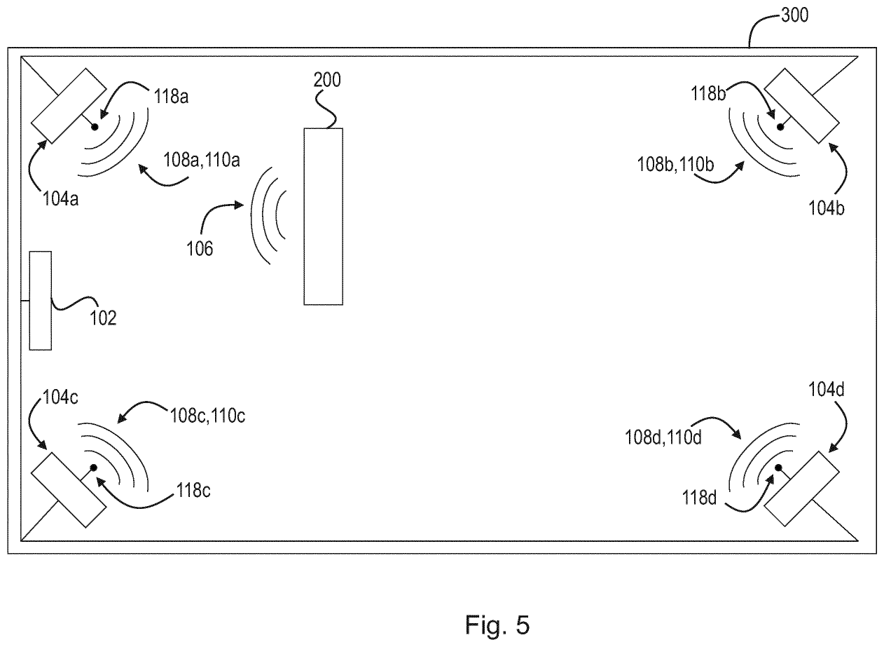

Further to his example, the support structure controller includes an antenna connector 165. In one example, the antenna connector 165 may be used to form a wired connection with a loop antenna 116 (see FIG. 4) arranged around a perimeter 302 (see FIGS. 4 and 5) of the support structure 300. In other examples, the antenna connector 165 may be used to connect to one or more other types of antenna.

As shown in FIG. 2, the support structure controller 102 includes a memory 125 and a processor 175. In some examples, the support structure controller 102 further includes a support structure transceiver 104. The support structure transceiver 104 is configured to facilitate communication with the electronic devices 200 arranged on or in the support structure. In a preferred example, support structure transceiver 104 retrieves device identification data 106 from the electronic devices 200 via RFID communication. The device identification data 106 may include a wide variety of data regarding the specific electronic device, such as device type 134, device weight 136, manufacturing location 138, date code 140 (corresponding to date of manufacture, inspection, shipment, etc.), batch code 142, and lot code 144. Further, the support structure transceiver 104 then wirelessly transmits, via any appropriate wireless protocol, device configuration data 108 to the electronic devices 200. The device configuration data 108 may include a wide variety of information related to programmable settings of the electronic device 200. If, according to a preferred example, the electronic device 200 is a luminaire, the device configuration data 108 may include CCT 112 and/or lumen output 114. In some examples, the support structure transceiver 104 is configured as an external component communicatively coupled to the support structure controller 102. In these examples, the system 100 may include multiple support structure transceivers 104 to fully cover the storage area of the support structure 300. In further examples, the processor 175 may use aspects of the captured device identification data 106 to update inventory data 162 stored in the memory 125 of the support structure controller 102. The inventory data 162 may collect and/or synthesize any aspects of the device identification data 106, and may include information regarding total device count, device type, etc.

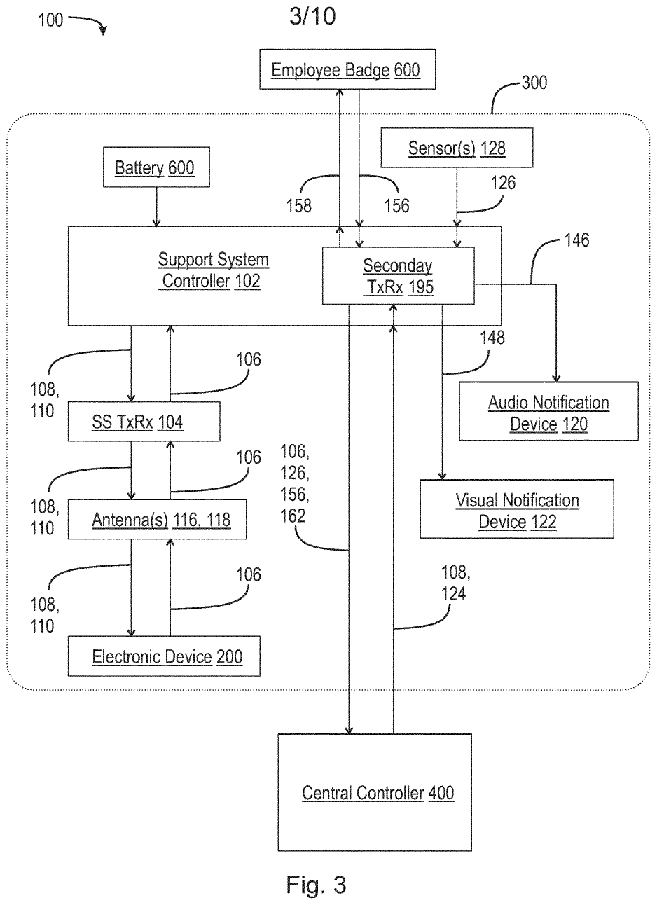

The support structure controller 102 may also include a secondary transceiver 195. This secondary transceiver 195 may be configured to facilitate wireless communication between the support structure controller 102 and any other components or systems. The secondary transceiver 195 may be enabled for any type of wireless communication protocol, such as Bluetooth, Wi-Fi, ultra-wideband (UWB), near field communication (NFC), RFID, or Zigbee. For example, the secondary transceiver 195 may facilitate retrieval of sensor data 128 captured by one or more sensors 126 positioned near (e.g., within a range of), coupled to, arranged on or within the support structure 300. In another example, the secondary transceiver 195 may issue audio notification commands 146 and/or visual notification commands 148 to one or more audio notification devices 120 (such as one or more speakers) (see FIG. 3) and/or visual notification devices 122 (such as a display screen or one or more LEDs) (see FIG. 3) associated with the support structure. The actuations may be used to indicate the status of the electronic devices 200 arranged on or within the support structure 102, such as that the electronic devices 200 are ready for shipment, or that one of the electronic devices 200 has been misplaced. In an even further example, the secondary transceiver 195 may facilitate communication between the support structure controller 102 and a central controller 400. The central controller 400 may be a local or remote computing device configured to collect, store, and process information regarding all of the electronic devices 200 on the support structure 300 (including device identification data 106 and/or sensor data 128), and to then generate device configuration data 108 to program the electronic devices 200 and/or inventory control data 124 to control the audio notification devices 120 and/or visual notification devices 122 associated with the support structure 300.

In some examples, the support structure controller 102 includes a user interface 150. As shown in FIG. 1, the user interface 150 may include a display 152 configured to show information regarding the electronic devices 200 within the support structure 300, or even information regarding the support structure 300 itself. The displayed information may be derived from the device identification data 106, the device configuration data 108, inventory control data 124, sensor data 126, inventory data 162, and/or any other data regarding the support structure 300 or the corresponding electronic devices 200. Further, the user interface 150 may be configured to receive information from the user via one or more user inputs 154. In FIG. 1, the user inputs 154 are depicted as three buttons, but any practical types of user inputs 154 may be used. The information entered via the user inputs 154 may be used by the support structure controller 102 to set the device configuration data 106 to be transmitted to the electronic device 200. With reference to FIG. 1, a user may use the user inputs 154 to set the CCT 112 of the electronic device 200 to 3500 K.

FIG. 3 illustrates an example functional block diagram of a system 100 for identifying and configuring one or more electronic devices 200 arranged on a support structure 300. The example system 100 of FIG. 3 includes a support structure control 102, a support structure transceiver 104, one or more antennas 116, 118, a secondary transceiver 195, an audio notification device 120, a visual notification 122, and one or more sensors 128 positioned in a same environment or area as the support structure 300, arranged on or within the support structure 300. The system 100 further includes a central controller 400 arranged a distance away from the support structure 300.

The support structure controller 102 is configured to use RFID communication to retrieve device identification data 106 from the electronic device 200. To do so, the support structure controller 102 provides an RFID activation signal 110 to the support structure transceiver 104. While in the example of FIG. 3 the support structure transceiver 104 is depicted as external to the support structure controller 102, in other examples, the support structure transceiver 104 may be arranged internally to the support structure controller 102. The support structure transceiver 104 utilizes one or more antennas 116, 118 to wirelessly transmit the RFID activation signal 110 in a three-dimensional space corresponding to the position of the electronic device 200. In one example, the support structure transceiver 104 uses a single loop antenna 116 arranged around a perimeter 302 (see FIG. 4) of the support structure 300 to transmit the RFID activation signal 110. In another example, the support structure transceiver 104 uses multiple discrete antennas 118 arranged around the support structure 300.

In response to receiving the RFID activation signal 110, the electronic device 200 responds by wirelessly transmitting device identification data 106 corresponding to the electronic device 200. In some examples, the device identification data 106 includes a device type 134, such as a make, model, or part number. The antenna(s) 116, 118 receive the device identification data 106 and provide device identification data 106 to the support structure controller 102 via the support structure transceiver 102.

In one example, having captured the device identification data 108, the support structure controller 102 retrieves device configuration data 108 corresponding to the electronic device 200 from memory 125 (see FIG. 2). In some examples where the electronic device 200 is a luminaire, the device configuration data 108 includes settings for CCT 112 and/or lumen output 114. The support structure controller 102 then wirelessly transmits the device configuration data 108, via the support structure transceiver 104 and antenna(s) 116, 118 to the electronic device 200. Thus, the electronic device 200 is now configured to illuminate according to the CCT 112 and/or the lumen output 114 received from the support structure controller 102. In some examples, the device configuration data 108 may be stored in the memory 125 upon manufacturing of the support structure controller 102. In other examples, a user may manually enter specific values for aspects of the device configuration data 108 via one or more user inputs 154 (see FIGS. 1 and 2) of a user interface 150 on the support structure controller 102.

In some examples, the support structure controller 102 communicates with the central controller 400 via the secondary transceiver 195 to retrieve the device configuration data 108. In some examples, the central controller 400 transmits, via the secondary transceiver 195, device configuration data 108 corresponding to a variety of electronic devices 200 to the support structure controller 102. The transmitted device configuration data 108 may be accompanied by additional data, such as a look-up table, pairing the device configuration data 108 to device identification data 106 to be retrieved from the electronic device 200.

In some examples, the support structure controller 102 transmits, via the secondary transceiver 195, the device identification data 106 retrieved from the electronic device 200 to the central controller 400. The central controller 400 then provides the support structure controller 102 with the device configuration data 108 corresponding to the provided device identification data 106. The device configuration data 108 from the central controller 400 is then transmitted to the electronic device 200 via the support structure transceiver 104 and the antenna(s) 116, 118. In further examples, the support structure controller 102 may also transmit inventory data 162 to the central controller 400 for storage, analysis, and/or further processing.

In some examples, the central controller 400 is configured to track inventory and other information regarding the electronic devices 200 stored in the support structure 300, as well as other electronic devices stored in other support structures. For example, a memory of the central controller 400 may be configured to store centralized inventory information (such as a database) based on the device identification data 106 received from the electronic devices 200 arranged on the support structure 300. This centralized inventory information could include a wide range of data regarding the electronic devices 200. For example, the centralized inventory information 402 could track device type 134, device weight 136, manufacturing location 138, date code 140, batch number 142, and/or lot number 144 (see FIG. 2) corresponding to the electronic devices 200. For example, the centralized inventory information 402 may track that a first support structure 300a stores two electronic devices 200a of Model A, and two electronic devices 200b of Model B, and that a second support structure 300b stores three electronic devices 200a of Model A, and one electronic device 200c of Model C. Further to this example, the centralized inventory information may be responsive to or serve as an aspect of Enterprise Resource Planning (ERP) and/or Systems Applications and Products in Data Processing (SAP) systems.

The inventory data 162 stored on the support structure controller 102 and/or the centralized inventory information stored on the central controller 400 may also reflect sensor data 126 (such as temperature data 128, humidity data 130, or weight data 132) captured by one or more sensors 128 associated with the support structure 300. The support structure controller 102 may wirelessly receive (via secondary transceiver 195) sensor data 126 transmitted by the sensor(s) 128. The secondary transceiver 195 may then wirelessly transmit the sensor data 126 to the central controller 400. The sensors 128 can be disposed within a same or common environment or area (e.g., room, portion of a room) as the support structure 300 to detect environmental conditions near or around the support structure 300. In some examples, one or more of the sensors 128 are arranged on or within the support structure 300 external to the support structure controller 102. In other examples, one or more of the sensors 128 are embedded within the support structure controller 102.

In some further examples, the support structure controller 102 is configured to generate notifications or alerts triggered by a wide array of eventualities and conditions, such as device selection for picking, potential inventory loss, and/or improper storage conditions. The support structure controller 102 may generate audio notification data 146 and/or visual notification data 148. In one example, the support structure controller 102 wirelessly transmits audio notification data 146 to an audio notification device 120 (such as a speaker) embedded within the support structure 102 to generate audio to alert a user. In another example, the support structure controller 102 wirelessly transmits visual notification data 148 to a visual notification device 122 (such as an indicator light emitting diode (LED) or display screen) arranged on or embedded in the support structure 102 to blink, change colors, display text, or otherwise alert a user to the triggering condition. FIG. 3 depicts the audio notification device 120 and the visual notification device 122 as arranged within the support structure 300 but external to the support structure controller 102. However, in other examples, the audio notification device 120 and/or the visual notification device 122 may be embedded within the support structure controller 102. In further examples, the support structure controller 102 may trigger aspects of the controller-embedded user interface 150 of FIG. 1 to alert the user.

In some examples, the support structure controller 102 generates the audio notification data 146 and/or the visual notification data 148 based on inventory control data 124 received from the central controller 400. For example, the inventory control data 124 may indicate that one or more electronic devices 200 are unexpectedly missing from the support structure 300. The audio notification data 120 may then trigger the audio notification device 120 to generate an alarm or siren sound. Similarly, the visual notification data 148 may then trigger the visual notification device 122 to generate a blinking or strobing light. These types of notifications may also be generated if the sensor data 126 indicates improper storage conditions (such as extreme temperature or humidity levels which could damage the electronic devices 200) or unexpectedly low weight measurements (corresponding to missing inventory).

In other examples, the central controller 400 may generate inventory control data 124 to indicate that the electronic devices 200 stored on the support structure 300 have been selected for a location change. For example, if the support structure is a pallet 300, the inventory control data 124 may generate audio and/or visual notification data 146, 148 to alert a warehouse worker or a forklift operator to pick the electronic devices 200 of the support structure 300, such as via blinking lights of the visual notification device 122. If the support structure 300 is a point-of-sale display stand, the inventory control data 124 may also trigger blinking lights of the visual notification 122 to alert a consumer to purchase the electronic device(s) 200. This inventory control data 124 may be generated according to the ERP and/or SAP systems communicating with the central controller. The color and/or blinking patterns of the lights of the visual notification 122 may correspond to information regarding an order number, order quantity, or any other relevant information.

In some examples, the support structure controller 102 can retrieve employee data 156 from a nearby employee badge 600. The secondary transceiver 195 may capture the employee data 156 using a variety of techniques, such as RFID or NFC communication. In the example of RFID communication, the secondary transceiver 195 may transmit a secondary RFID activation signal 158 to the employee badge 600, triggering the employee badge 600 to respond by transmitting the employee data 156. Aspects of the employee data 156 can be stored in the memory 125 of the support structure controller 102 or transmitted to the central controller 400. As shown in FIG. 1, aspects of the employee data 156 (in this example, an employee number) may be shown on the display 152 of the user interface 150 of the support structure controller 102. The employee data 156 may include additional information, such as employee name, employee title, employee location, etc.

In some examples, the support structure controller 102 is powered by a battery 600. The battery 600 may be arranged on or embedded within the support structure 300. The external battery 600 may be rechargeable. If the battery 600 is embedded within the support structure 300, the support structure 300 may have an electrical socket coupled to the battery 600 to facilitate charging. In further examples, the battery 600 may be arranged internally within the support structure controller 102.

FIG. 4 illustrates an example of the present disclosure where the support structure controller 102 comprises an internal support structure transceiver 104 (see FIG. 2) configured to wirelessly communicate with an electronic device 200 via a loop antenna 116. In this arrangement, the loop antenna 116 is arranged around a perimeter 302 of a support structure 300. The electronic device 200 is arranged both within the perimeter 302 of the support structure 300 as well as within an aperture 160 formed by the loop antenna 116. In this way, the loop antenna 116 is configured to enable wireless communication between the support structure controller 102 and any electronic devices 200 arranged within the aperture 160.

As shown in the example of FIG. 4, the support structure controller 102 uses the support structure transceiver 104 and the loop antenna 116 to transmit a RFID activation signal 110 within the aperture 160. The RFID activation signal 110 is received by the electronic device 200 arranged within the aperture 160, which responds by transmitting device identification data 106. The device identification data 106 is captured by the loop antenna 116, which provides the device identification data 106 to the support structure controller 102 via the support structure transceiver 104. Based on the received device identification data 106, the support structure controller 102 determines device configuration data 108 to program the electronic device 200. The support structure controller 102 uses the support structure transceiver 104 and the loop antenna 116 to transmit the device configuration data 108 within the aperture 160. The electronic device 200 then receives the device configuration data 108 and updates its internal settings accordingly.

In some examples, the support structure controller 102 and/or the loop antenna 116 are integrated within the support structure 300. This integration may occur during manufacturing of the support structure 300. In other examples, the support structure controller 102 and/or the loop antenna 116 are retrofit on the support structure 300 following manufacturing.

FIG. 5 illustrates a variation of the configuration of FIG. 4 replacing the internal support structure transceiver 104 and the loop antenna 116 with four external support structure transceivers 104a-d each coupled to a discrete antenna 118a-d. The four external support structure transceivers 104a-d are each communicatively coupled to the support structure controller 102 via a wired connection. By positioning transceivers 104a-d and antennas 118a-d around the support structure 300, wireless coverage similar to the loop antenna 116 configuration of FIG. 4 may be achieved. In this way, the discrete antenna 118a-d configuration of FIG. 5 may be a cheaper, more flexible retrofit alternative to the loop antenna 116. Further, while FIG. 5 depicts four transceivers 104a-d and four antennas 118a-d, any practical number of transceivers 104 and antennas 118 may be used.

As shown in the example of FIG. 5, the support structure controller 102 uses the support structure transceivers 104a-d and the discrete antenna 118a-d to transmit RFID activation signals 110a-d. In this example, all four support structure transceivers 104a-d and discrete antennas 118a-d transmit RFID activations signals 110a-d. A first RFID activation signal 110a (transmitted by a first discrete antenna 118a) is received by the electronic device 200 due to the proximity of the electronic device 200 to the first discrete antenna 118a. The electronic device 200 responds to the first RFID activation signal 110a by transmitting device identification data 106. The device identification data 106 is received by the discrete antenna 118a due to the proximity of the first discrete antenna 118a to the electronic device 200. The first discrete antenna 118a then provides the device identification data 106 to the support structure controller 102 via the first external support structure transceiver 104a. Based on the received device identification data 106, the support structure controller 102 determines device configuration data 108a to program the electronic device 200. The support structure controller 102 then uses each of the support structure transceivers 104a-d and the discrete antennas 118a-d to transmit the device configuration data 108a-d. The electronic device 200 then receives the device configuration data 108a transmitted by the first discrete antenna 118a and updates its internal settings accordingly.

FIG. 6 is an isometric view of a system 100 for identifying and configuring one or more electronic devices 200 arranged on a support structure 300 embodied as a plastic pallet. In the example of FIG. 6, the support structure controller 102 and the loop antenna 116 of FIG. 4 are integrated into the support structure 300 during manufacturing. Further, a battery 600 for powering the support structure controller 102 is also integrated into the support structure 300. A total of eight electronic devices 200 are arranged in boxes on top of the support structure 300. As described with reference to FIG. 4, the support structure controller 102 may use the loop antenna 116 to capture device configuration data 106 from the electronic devices 200 arranged within the aperture 160 (see FIG. 2) of the loop antenna 116, as well as to transmit device identification data 108 to the electronic devices 200. In this example, a control panel 700 is also integrated into the support structure 300. The control panel 700 may serve as an additional interface to service and/or program the support structure controller 102. As shown in FIG. 6, the support structure controller 102, the battery 600, and the control panel 700 are recessed into the support structure 300 for additional protection.

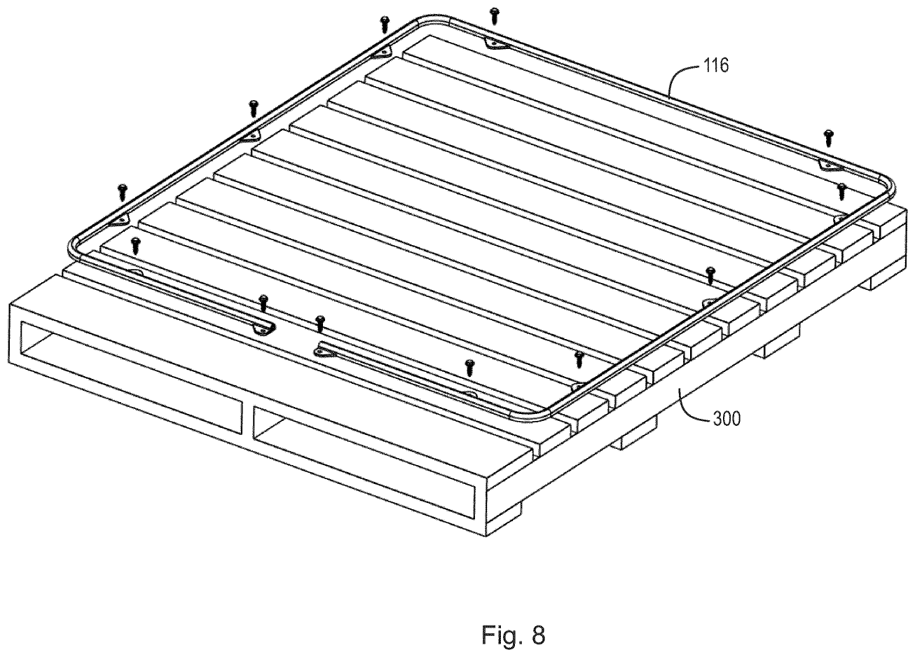

FIG. 7 is a variation of the system of FIG. 6 wherein the support structure controller 102 and the loop antenna 116 are retrofit onto a support structure 300 embodied as a wooden pallet. This retrofit configuration may enable end users to utilize the identification and configuration aspects of the system 100 at a lower costs than a fully integrated unit. While FIG. 7 discloses a wooden pallet, the support structure 300 may comprise any material(s) (such as woods or plastics) capable of physically supporting the retrofit controller 102, loop antenna 116, and the boxed electronic devices 200, while introducing minimal RF interference into the wireless communications between the loop antenna 116 and the electronic devices 200. As shown in FIG. 7, the support structure controller 102 includes a pair of recessed walls arranged along the length of the rectangular controller 102. FIG. 8 illustrates an exploded view of the support structure 300 and the loop antenna 116 of FIG. 7 showing how the loop antenna 116 is secured to the support structure 300 via a series of fasteners.

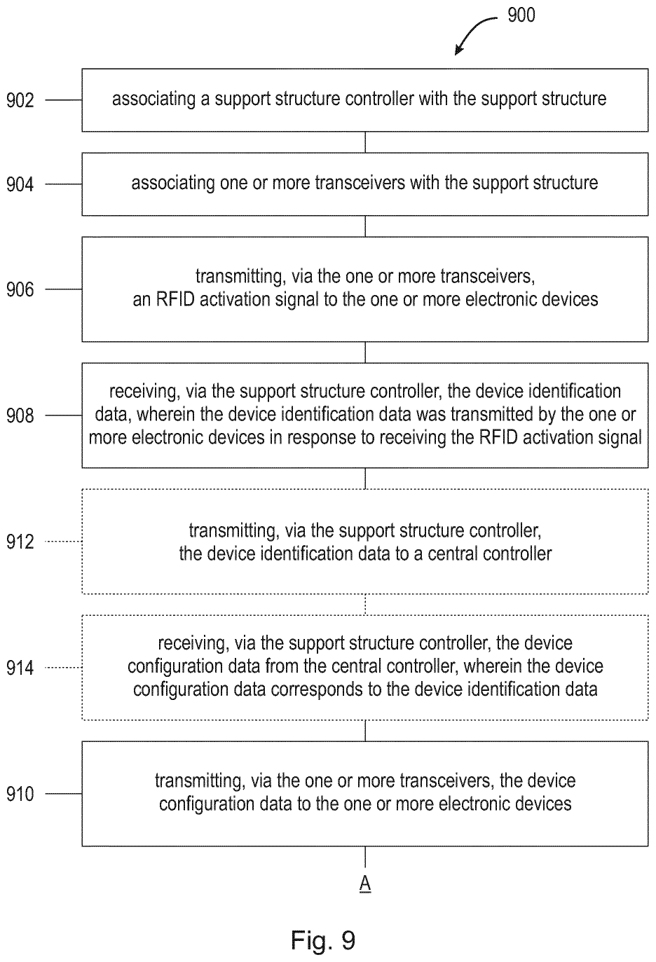

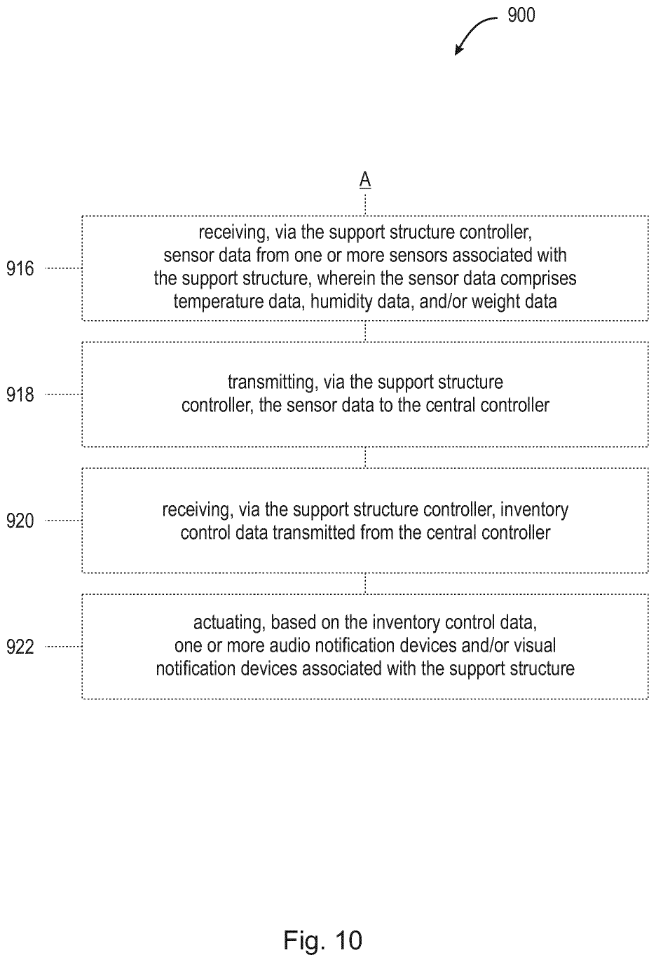

FIGS. 9 and 10 are flowcharts of a method 900 for identifying and configuring one or more electronic devices. The method 900 includes associating or coupling 902 a support structure controller with the support structure. The support structure controller includes a memory and a processor. The memory stores and comprises device identification data and device configuration data. The method 900 further includes associating 904 one or more support structure transceivers with the support structure. The one or more support structure transceivers are communicatively coupled to the support structure controller. In embodiments, the method 900 can include coupling, connecting or otherwise attaching the one or more support transceivers to the support structure. The method 900 further includes transmitting 906, via the one or more support structure transceivers, an RFID activation signal to the one or more electronic devices. The method 900 further includes receiving 908, via the support structure controller, the device identification data. The device identification data was transmitted by the one or more electronic devices in response to receiving the RFID activation signal. The method 900 further includes transmitting 910, via the one or more support structure transceivers, the device configuration data to the one or more electronic devices.

According to an example, the method 900 further includes transmitting 912, via the support structure controller, the device identification data to a central controller. The method 900 may further include receiving 914, via the support structure controller, the device configuration data from the central controller. The device configuration data corresponds to the device identification data.

According to an example, the method 900 further includes receiving 916, via the support structure controller, sensor data from one or more sensors associated with the support structure. The sensor data may include temperature data, humidity data, and/or weight data. The method 900 may further include transmitting 918, via the support structure controller, the sensor data to a central controller. The method 900 may further include receiving 920, via the support structure controller, inventory control data transmitted from the central controller. The method 900 may further include actuating 922, based on the inventory control data, one or more audio notification devices and/or visual notification devices associated with the support structure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software, or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A system for identifying and configuring one or more electronic devices arranged on a support structure, the system comprising:
a support structure controller coupled to the support structure, the support structure controller comprising a memory and a processor, wherein the memory comprises device identification data and device configuration data, wherein the support structure comprises at least one of: a pallet, container, storage module or a point-of-sale display;
one or more support structure transceivers communicatively coupled to the support structure controller, the one or more support structure transceivers each configured to:
transmit a radio frequency identification activation signal to the one or more electronic devices;
receive the device identification data transmitted by the one or more electronic devices in response to receiving the RFID activation signal; and
transmit the device configuration data; retrieved from the memory using the device identification data to the one or more electronic devices.

2. The system of claim 1, wherein the one or more electronic devices are luminaires, and wherein the device configuration data comprises a correlated color temperature (CCT) and/or a lumen output.

3. The system of claim 1, wherein a support structure transceiver of the one or more support structure transceivers is electrically coupled to a loop antenna arranged around a perimeter of the support structure, and wherein the one or more electronic devices are arranged within the perimeter.

4. The system of claim 1, wherein the one or more support structure transceivers are arranged at one or more locations on or within the support structure, and wherein each of the one or more support structure transceivers is electrically coupled to an antenna.

5. The system of claim 1, wherein the support structure controller is communicatively coupled to a central controller.

6. The system of claim 5, wherein the support structure controller is configured to:
transmit the device identification data to the central controller; and
receive the device configuration data from the central controller, wherein the device configuration data corresponds to the device identification data.

7. The system of claim 5, wherein the support structure controller is configured to actuate one or more audio notification devices and/or visual notification devices based on inventory control data received from the central controller.

8. The system of claim 5, wherein the support structure controller is further configured to receive sensor data from one or more sensors, wherein the support structure controller is configured to transmit the sensor data to the central controller, and wherein the sensor data comprises temperature data, humidity data, and/or weight data.

9. The system of claim 1, wherein the support structure is a pallet, a point-of-sale display stand, or a storage module.

10. The system of claim 1, wherein the support structure controller and/or the one or more support structure transceivers are arranged on or within the support structure.

11. The system of claim 1, wherein the support structure controller and/or the one or more support structure transceivers are integrated within the support structure.

12. The system of claim 1, wherein the device identification data comprises device type, device weight, manufacturing location, date code, batch number and/or lot number.

13. A method for identifying and configuring one or more electronic devices arranged on a support structure, the method comprising:
coupling a support structure controller to the support structure, the support structure controller comprising a memory and a processor, wherein the memory comprises device identification data and device configuration data, wherein the support structure comprises at least one of: a pallet, container, storage container, storage module or a point-of-sale display;
communicatively coupling one or more support structure transceivers to the support structure controller:
transmitting, via the one or more support structure transceivers, a radio frequency identification (RFID) activation signal to the one or more electronic devices;
receiving, via the support structure controller, the device identification data, wherein the device identification data was transmitted by the one or more electronic devices in response to receiving the RFID activation signal; and
transmitting, via the one or more support structure transceivers, the device configuration data retrieved from the memory using the device identification data to the one or more electronic devices.

14. The method of claim 13, further comprising:
transmitting, via the support structure controller, the device identification data to a central controller; and
receiving, via the support structure controller, the device configuration data from the central controller, wherein the device configuration data corresponds to the device identification data.

15. The method of claim 13, further comprising:
receiving, via the support structure controller, sensor data from one or more sensors, wherein the sensor data comprises temperature data, humidity data, and/or weight data;
transmitting, via the support structure controller, the sensor data to a central controller;
receiving, via the support structure controller, inventory control data transmitted from the central controller; and
actuating, based on the inventory control data, one or more audio notification devices and/or visual notification devices.
